(19) United States
(12) Patent Application Publication
(10) Pub. No.: US 2026/0167269 A1
(43) Pub. Date: Jun. 18, 2026

(54) STORAGE AREA LOAD FLOOR ASSEMBLY

(71) Applicant: Scout Motors Inc., Tysons, VA (US)

(72) Inventor: Robert Shipley, Westland, MI (US)

(21) Appl. No.: 18/985,279

(22) Filed: Dec. 18, 2024

(51) Int. Cl. B62D 25/08

(52) U.S. Cl. CPC B62D 25/087

(57) ABSTRACT

A storage area load floor assembly may include a tub sized to cover a vehicle storage area and including a tub wall and a tub floor. A storage area load floor assembly may include a dual plane load floor including a load wall removably coupled to the tub wall, and a floor panel movable relative to the load wall between a storage position inhibiting access to the tub floor and a raised position providing access to the tub floor.

### BACKGROUND

This disclosure relates to vehicle storage areas. More particularly, this disclosure relates to load floors for vehicle storage areas.

### SUMMARY

In some aspects, the techniques described herein relate to a storage area load floor assembly including: a tub sized to cover a vehicle storage area and including a tub wall and a tub floor; and a dual plane load floor including a load wall removably coupled to the tub wall, and a floor panel movable relative to the load wall between a storage position inhibiting access to the tub floor and a raised position providing access to the tub floor.

In some aspects, the techniques described herein relate to a storage area load floor assembly, wherein the tub further includes a tub ledge formed in the tub wall and a tub post extending from the tub ledge, and wherein the load wall includes a load upper ledge defining a load aperture sized to receive the tub post.

In some aspects, the techniques described herein relate to a storage area load floor assembly, wherein the tub further includes two tub posts, and wherein the load wall defines two load apertures.

In some aspects, the techniques described herein relate to a storage area load floor assembly, wherein the load wall includes a load upper ledge coupled to the tub wall, an accessory panel coupled to the load upper ledge, and a load lower ledge coupled to the accessory panel.

In some aspects, the techniques described herein relate to a storage area load floor assembly, wherein the floor panel is supported by the load lower ledge.

In some aspects, the techniques described herein relate to a storage area load floor assembly, wherein the floor panel is connected to the load wall by a hinge.

In some aspects, the techniques described herein relate to a storage area load floor assembly, wherein the tub includes a front tub lip, and wherein the floor panel is supported by the front tub lip.

In some aspects, the techniques described herein relate to a storage area load floor assembly, wherein the floor panel rotates between the storage position and the raised position.

In some aspects, the techniques described herein relate to a storage area load floor assembly, wherein the floor panel is selectively maintained in the raised position via a magnet.

In some aspects, the techniques described herein relate to a storage area load floor assembly, wherein an under-floor compartment is defined between the floor panel and the tub floor.

In some aspects, the techniques described herein relate to a storage area load floor assembly, further including a gear rack removably coupled to the load wall.

In some aspects, the techniques described herein relate to a storage area load floor assembly, wherein the floor panel is arranged perpendicular to the load wall in the storage position.

In some aspects, the techniques described herein relate to a storage area load floor assembly, wherein the tub further includes a tub seal shaped to selectively engage a hood.

In some aspects, the techniques described herein relate to a storage area load floor assembly, wherein the tub includes component covers shaped to accommodate vehicle components located in the vehicle storage area.

In some aspects, the techniques described herein relate to a storage area load floor assembly, wherein the tub defines an accessory mount accessible when the dual plane load floor is installed on the tub.

In some aspects, the techniques described herein relate to a vehicle including: a frunk; a frunk hood rotatably coupled to the frunk; a tub shaped to cover the frunk, the tub including a tub wall, a tub ledge formed in the tub wall, a tub post extending from the tub ledge, a frunk tub seal surrounding the tub wall and sealingly engaged with the frunk hood, and a tub floor surrounded by the tub wall; and a dual plane load floor including a load wall including a load upper ledge defining a load aperture sized to receive the tub post, and a floor panel movable relative to the load wall between a storage position inhibiting access to the tub floor and a raised position providing access to the tub floor.

In some aspects, the techniques described herein relate to a vehicle, wherein the tub further includes a front tub lip and the floor panel engages the front tub lip in the storage position.

In some aspects, the techniques described herein relate to a vehicle, wherein an under-floor compartment is defined between the floor panel and the tub floor.

In some aspects, the techniques described herein relate to a vehicle including: a storage compartment; a vehicle component positioned within the storage compartment; a hood selectively covering the storage compartment; and a storage area load floor assembly coupled to the storage compartment and including a tub covering the vehicle component, and a dual plane load floor removably coupled to the tub and including a load wall and a floor panel, wherein an under-floor compartment is defined between the floor panel and the tub.

In some aspects, the techniques described herein relate to a vehicle, wherein the floor panel rotates relative the load wall between a storage position and a raised position.

This summary is illustrative only and is not intended to be in any way limiting. Other aspects and advantages of the devices or processes described herein will become apparent in the detailed description set forth herein, taken in conjunction with the accompanying figures, wherein like reference numerals refer to like elements.

### BRIEF DESCRIPTION OF DRAWINGS

The device is explained in even greater detail in the following drawings. The drawings are merely exemplary and certain features may be used singularly or in combination with other features. The drawings are not necessarily drawn to scale.

FIG. 1 is a side view of a vehicle, according to some implementations.

FIG. 2 is a side view of another vehicle, according to some implementations.

FIG. 3 is a perspective view of a storage area load floor assembly for the vehicle of FIG. 1 or FIG. 2, according to some implementations.

FIG. 4 is a section view of the storage area load floor assembly of FIG. 3, according to some implementations.

FIG. 5 is a perspective view of a tub of the storage area load floor assembly of FIG. 3, according to some implementations.

FIG. 6 is another perspective view of the tub of the storage area load floor assembly of FIG. 3, according to some implementations.

FIG. 7 is a top view of the tub of the storage area load floor assembly of FIG. 3, according to some implementations.

FIG. 8 is a section view of the tub of the storage area load floor assembly taken along line 8-8 of FIG. 7, according to some implementations.

FIG. 9 is a section view of the tub of the storage area load floor assembly taken along line 9-9 of FIG. 7, according to some implementations.

FIG. 10 is a section view of the tub of the storage area load floor assembly taken along line 10-10 of FIG. 7, according to some implementations.

FIG. 11 is a perspective view of a load floor of the storage area load floor assembly of FIG. 3, according to some implementations.

### DETAILED DESCRIPTION

Following below are more detailed descriptions of concepts related to, and implementations of, methods, apparatuses, and systems for a storage area load floor assembly. The figures illustrate exemplary implementations in detail and the present disclosure is not limited to the details or methodology set forth in the description or illustrated in the figures. The terminology used herein is for the purpose of description only and should not be regarded as limiting.

As used herein the term “battery electric vehicle” means a vehicle (e.g., a passenger vehicle, a delivery vehicle, etc.) for use by humans or a self-driving vehicle that is powered entirely by a battery system including battery cells. In other words, no fossil fuels are utilized, no internal combustion engine is present in the vehicle, and no alternative forms of propulsion is provided (e.g., hydrogen fuel cells, etc.). In some implementations, features of this disclosure can be used with hybrid vehicles, such as plug-in hybrid vehicles, hybrid vehicles (e.g., full hybrid vehicles), mild hybrid electric vehicles, and range extended hybrid vehicles. In some implementations, a battery system of a battery electric vehicle can be charged by an onboard generator powered by an internal combustion engine burning fuel.

As used herein, the term “frunk” means a storage area arranged at a front of a vehicle. Typically, a battery electric vehicle will include a frunk where an internal combustion engine powered vehicle may have an engine.

Referring to the figures generally, the various implementations disclosed herein relate to systems, apparatuses, and methods for a storage area load floor assembly that includes a tub that can be installed in a frunk of a vehicle, and a load floor that can be installed into and removed from the tub to provide flexible storage solutions.

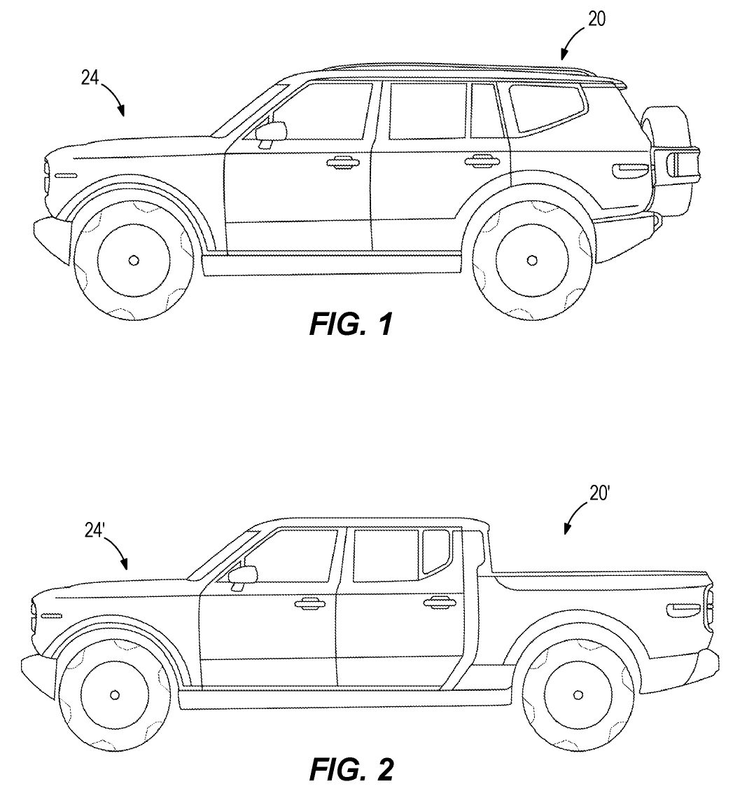

As shown in FIG. 1, a vehicle in the form of a sport utility vehicle 20 includes a storage area in the form of a frunk 24. In some implementations, the sport utility vehicle 20 is a battery electric vehicle. As shown in FIG. 2, a vehicle in the form of a pickup truck 20’ includes a storage area in the form of a frunk 24’. In some implementations, the pickup truck 20’ is a battery electric vehicle. The following description will refer to the frunk 24 of the sport utility vehicle 20 and it should be understood that the following disclosure is also applicable to the frunk 24’ of the pickup truck 20’. Additionally, while the following disclosure is directed to the frunk 24 (or the frunk 24’), the storage area could include other areas of the vehicle within the scope of this disclosure.

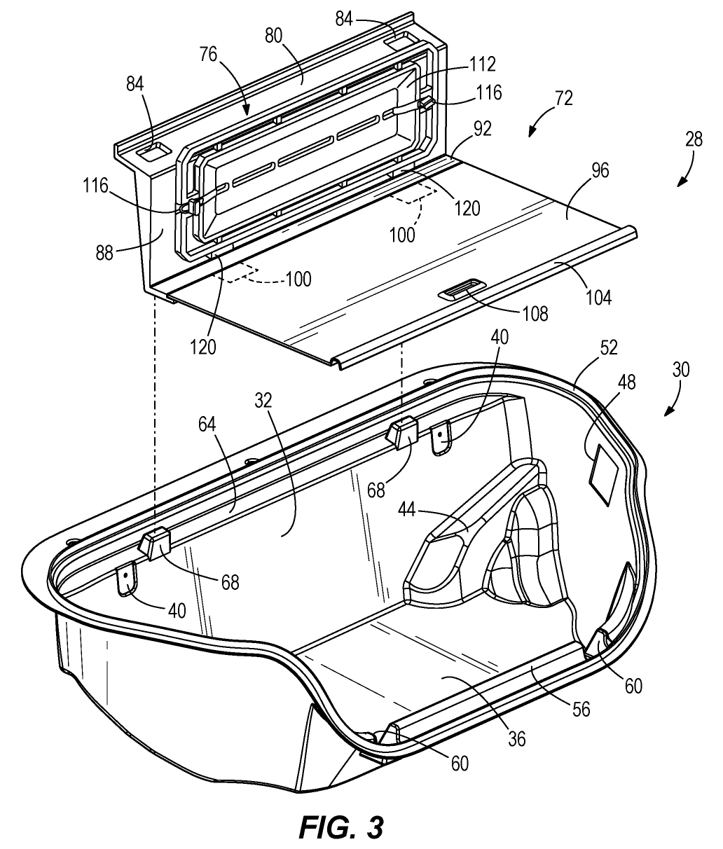

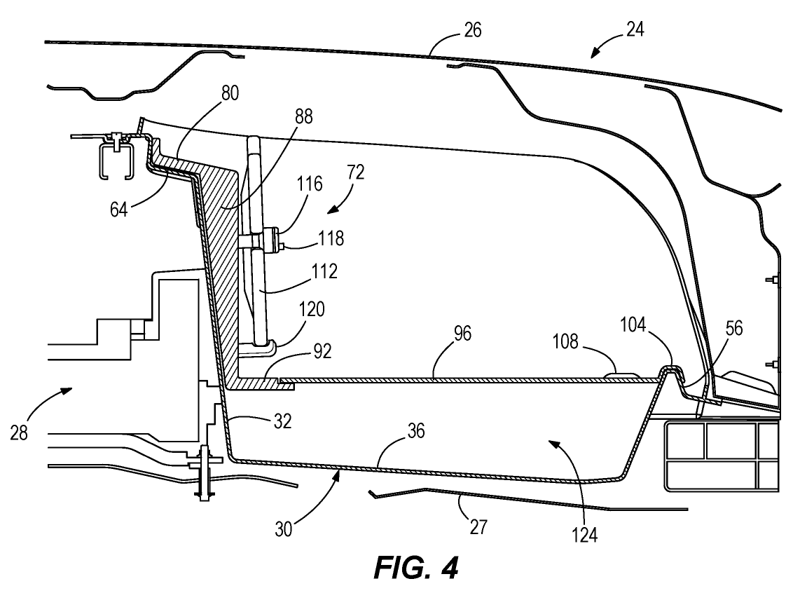

As shown in FIG. 3, a storage area load floor assembly 28 is sized to be supported within the frunk 24 and includes a tub 30 that covers vehicle components 27 (see FIG. 4) such as a vehicle frame, shock towers, suspension components, etc. The storage area load floor assembly 28 is also sized to fit under a frunk hood 26 (see FIG. 4). In some implementations, the tub 30 is formed of a polymer or a composite material.

The tub 30 defines a tub wall 32 extended upward from a tub floor 36. The tub 30 defines mounting features 40 (e.g., apertures, clips, etc.) for attaching the tub 30 to the frunk 24 and defines component covers 44 that are shaped to accommodate the vehicle components 27. In some implementations, the tub 30 includes an accessory mount location 48 (e.g., for a control panel, electrical components, air compressor interface, etc.). A frunk tub seal 52 extends around a perimeter of the tub 30 and is shaped to sealingly engage the frunk hood 26.

A front area of the tub 30 defines a front tub lip 56 and two tub recesses 60. In some implementations, the front tub lip 56 extends parallel to a front portion of the frunk tub seal 52. In some implementations, the front tub lip 56 is shaped to conform to a front structural edge of the vehicle frame or crash structure. In some implementations, the two tub recesses 60 are used for mounting the tub 30 to the frunk 24. In some implementations, the two tub recesses 60 provide a mounting point for other accessories. In some implementations, more than two tub recesses 60 or more than two tub recesses 60 are provided. In some implementations, the two tub recesses 60 are eliminated.

A tub shoulder or tub ledge 64 is formed on a rear side of the tub wall 32. In some implementations, the tub ledge 64 is shaped to conform to a frunk hood cross-brace ledge of the vehicle frame. Two tub posts 68 extend from the tub ledge 64. In some implementations, more than two tub posts 68 or less than two tub posts 68 are provided.

The storage area load floor assembly 28 also includes a dual plane load floor 72 that is selectively supported by, and removable from the tub 30. The dual plane load floor 72 include a load wall 76 defining a load upper ledge 80 shaped to conform to the tub ledge 64 of the tub 30. Two load apertures 84 are formed in the load upper ledge 80 and shaped to receive the two tub posts 68 of the tub 30. An accessory panel 88 extends downward from the load upper ledge 80 and a load lower ledge 92. A floor panel 96 is connected to the load lower ledge 92 via hinges 100. In some implementations, the hinges 100 are eliminated and the floor panel 96 is removably connected to the load lower ledge 92. In some implementations, the accessory panel 88 provides an additional flat vertical, or near vertical surface within the frunk 24 to secure accessories and/or good in a cantilevered position. In some implementations, the accessory panel 88 is arranged perpendicular to the floor panel 96. As used herein, “dual plane” means two surfaces (e.g., the accessory panel 88 and the floor panel 96) that are configured to provide storage and that are arranged oblique to one another. For example, in some implementations, the accessory panel 88 is arranged perpendicular to the floor panel 96. In some implementations, the accessory panel 88 is arranged oblique to the floor panel 96 at a non-perpendicular angle. In some implementations, the accessory panel 88 and/or the floor panel 96 are non-planar. In some implementations, each of the accessory panel 88 and the floor panel 96 define planar storage surfaces.

The floor panel 96 includes a floor panel lip 104 sized to shingle over or cover and engage with the front tub lip 56 and a handle 108. In some implementations, the handle 108 includes or is connected to a latching mechanism that selectively maintains the floor panel 96 in position relative to the tub 30. In some implementations, the dual plane load floor 72 is removable from the tub 30 as a single unit with the floor panel 96 connected to the load wall 76 via the hinges 100. In some implementations, the floor panel 96 and the load wall 76 are separate components and are separately removable from the tub 30. The floor panel 96 is positioned near level with the front tub lip 56 so that the user can comfortably use the floor panel 96 as a seat. In some implementations, the floor panel 96 is substantially planal or flat and elevates cargo above the contours of the tub floor 36. In some implementations, the floor panel 96 is sized to support large items such as golf clubs or luggage.

In some implementations, a gear rack 112 is removably supported by the accessory panel 88 via pins 116 and support brackets 120. In some implementations, the pins 116 and the support brackets 120 are removably connected to the accessory panel 88 so that the dual plane load floor 72 can be used with, or without the gear rack 112. The gear rack 112 is structured to support a variety of accessories (e.g., pouches, bags, molle systems, boxes, organizers, etc.). In some implementations, the gear rack 112 is removable from the pins 116 and the support brackets 120 so that mounted accessories can be easily mounted and removed from the dual plane load floor 72.

As shown in FIG. 4, an under-floor compartment 124 is formed between the dual plane load floor 72 and the tub 30 within the frunk 24. A user can access the under-floor compartment 124 by lifting the floor panel 96. In some implementations, the under-floor compartment 124 is sized to hold smaller items such as charge cables, gloves, tools, etc.

In some implementations, the floor panel 96 is movable between a storage position (shown in FIG. 4) and a raised position providing access to the under-floor compartment 124. In some implementations, the dual plane load floor 72 includes magnets 118 than selectively maintain the floor panel 96 in the raised position to provide convenient access to the under-floor compartment 124.

The storage area load floor assembly 28 provides a flat load floor for storing cargo without decreasing the overall geometric volume of the frunk 24 compartment. The storage area load floor assembly 28 allows for the incorporation of accessories such as an adaptive carry system including the gear rack 112. The storage area load floor assembly 28 provides an additional separate compartment (i.e., the under-floor compartment 124) for organization of stored items. In some implementations, the dual plane load floor 72 is provided as an optional feature separate from the tub 30. For example, a base level sport utility vehicle 20 includes the tub 30 and the dual plane load floor 72 is provided as an optional component. This allows the sport utility vehicle 20 to be provided as a base vehicle for a lower cost, and then the user can choose to add the dual plane load floor 72 as an addition or accessory after purchase. The storage area load floor assembly 28 allows for features to be added/removed easily by the user without altering the overall assembly (e.g., little to no fasteners required). The dual plane load floor 72 provides elevated positioning for packaging of basket of goods items (e.g., golf clubs, carry-on luggage, etc.) for better packaging and protection of goods. The storage area load floor assembly 28 also provides additional space for branding / aftermarket optimization depending on user desires

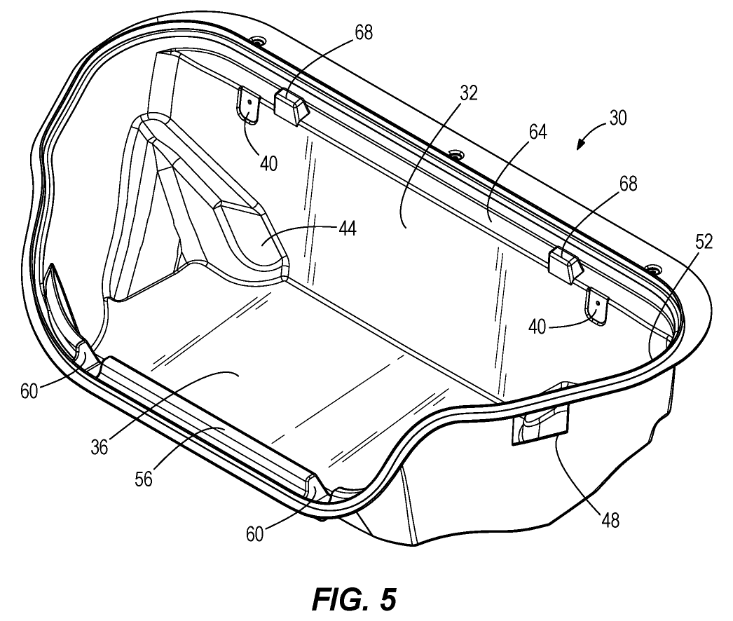

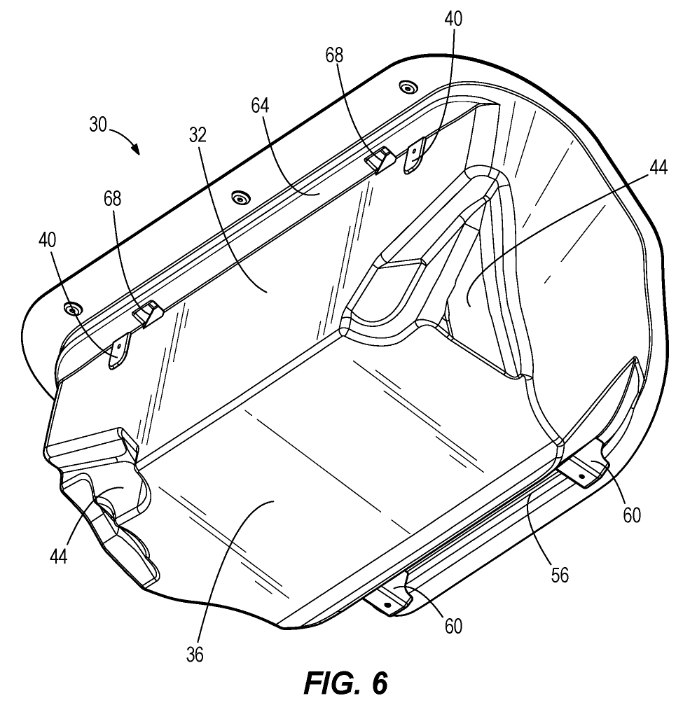

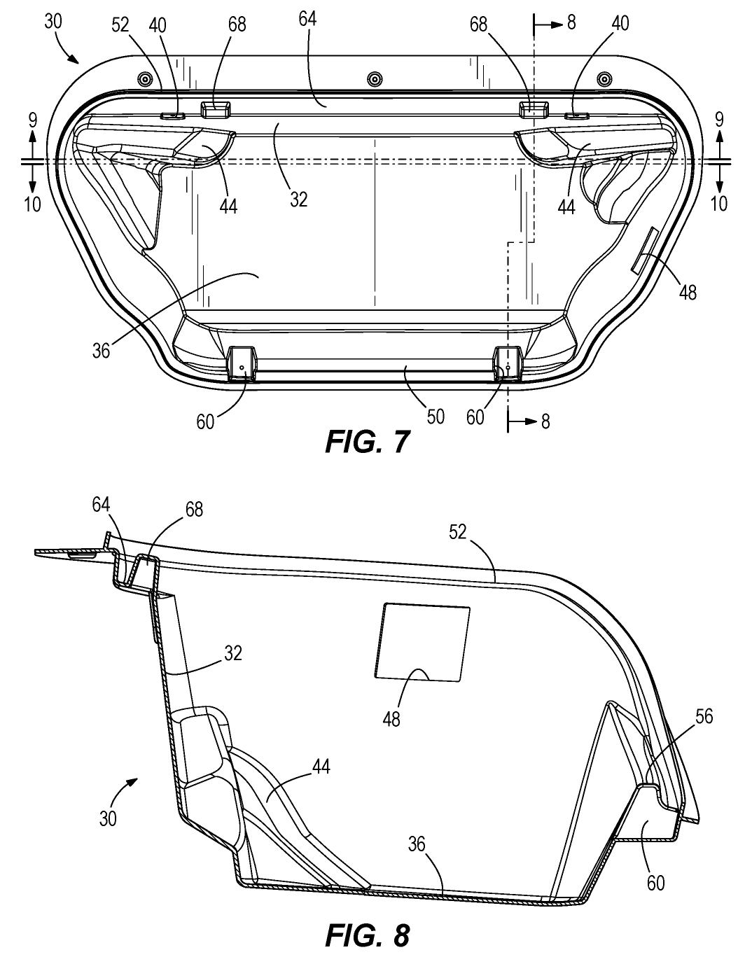

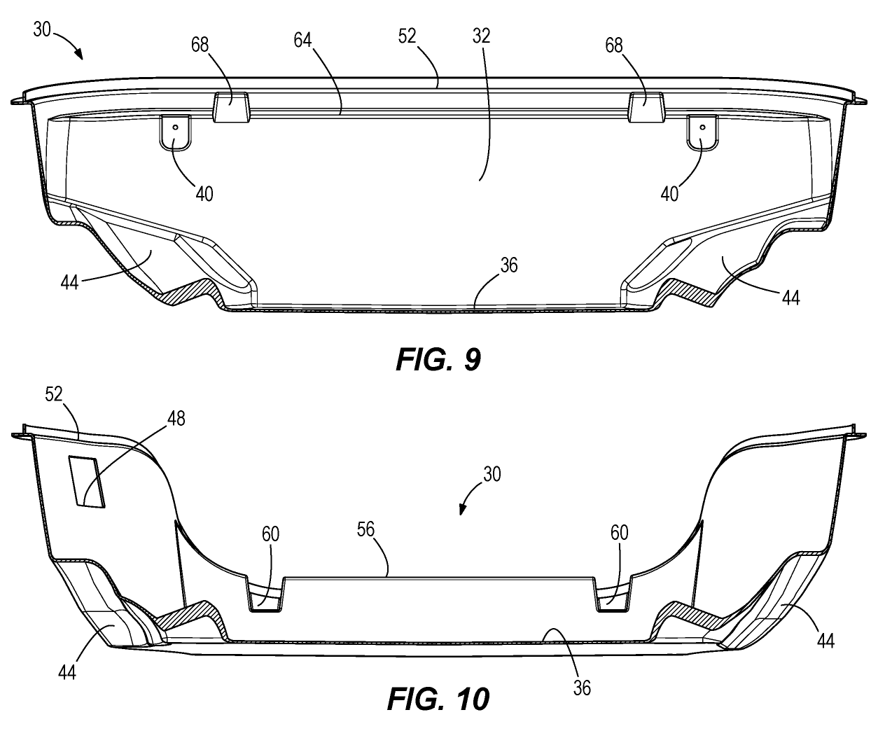

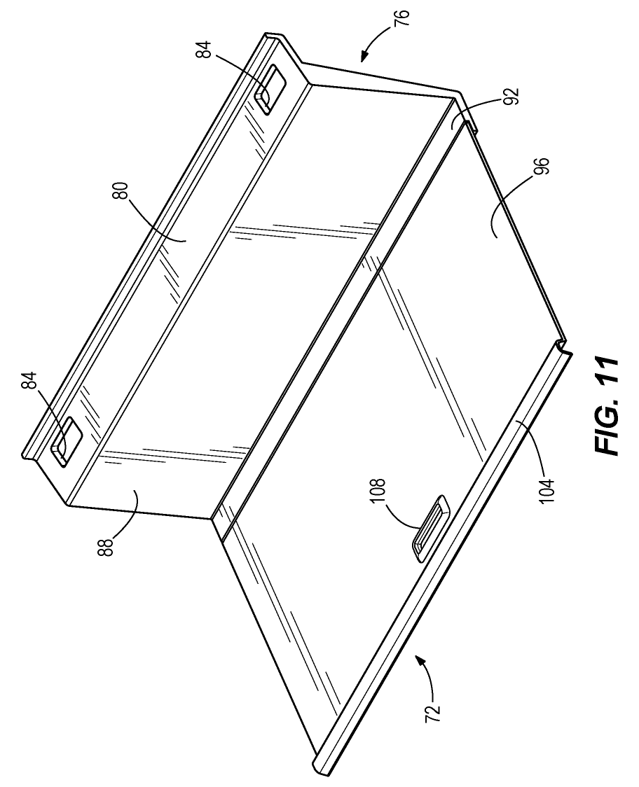

FIGS. 5-11 show additional views of the tub 30 and the dual plane load floor 72 sop that features can be more easily understood.

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

What is claimed is:

1. A storage area load floor assembly comprising:
a tub sized to cover a vehicle storage area and including a tub wall and a tub floor; and
a dual plane load floor including
a load wall removably coupled to the tub wall, and
a floor panel movable relative to the load wall between a storage position inhibiting access to the tub floor and a raised position providing access to the tub floor.

2. The storage area load floor assembly of claim 1, wherein the tub further includes a tub ledge formed in the tub wall and a tub post extending from the tub ledge, and
wherein the load wall includes a load upper ledge defining a load aperture sized to receive the tub post.

3. The storage area load floor assembly of claim 2, wherein the tub further includes two tub posts, and
wherein the load wall defines two load apertures.

4. The storage area load floor assembly of claim 1, wherein the load wall includes a load upper ledge coupled to the tub wall, an accessory panel coupled to the load upper ledge, and a load lower ledge coupled to the accessory panel.

5. The storage area load floor assembly of claim 4, wherein the floor panel is supported by the load lower ledge.

6. The storage area load floor assembly of claim 1, wherein the floor panel is connected to the load wall by a hinge.

7. The storage area load floor assembly of claim 1, wherein the tub includes a front tub lip, and
wherein the floor panel is supported by the front tub lip.

8. The storage area load floor assembly of claim 1, wherein the floor panel rotates between the storage position and the raised position.

9. The storage area load floor assembly of claim 1, wherein the floor panel is selectively maintained in the raised position via a magnet.

10. The storage area load floor assembly of claim 1, wherein an under-floor compartment is defined between the floor panel and the tub floor.

11. The storage area load floor assembly of claim 1, further comprising a gear rack removably coupled to the load wall.

12. The storage area load floor assembly of claim 1, wherein the floor panel is arranged perpendicular to the load wall in the storage position.

13. The storage area load floor assembly of claim 1, wherein the tub further includes a tub seal shaped to selectively engage a hood.

14. The storage area load floor assembly of claim 1, wherein the tub includes component covers shaped to accommodate vehicle components located in the vehicle storage area.

15. The storage area load floor assembly of claim 1, wherein the tub defines an accessory mount accessible when the dual plane load floor is installed on the tub.

16. A vehicle comprising:
a frunk;
a frunk hood rotatably coupled to the frunk;
a tub shaped to cover the frunk, the tub including
a tub wall,
a tub ledge formed in the tub wall,
a tub post extending from the tub ledge,
a frunk tub seal surrounding the tub wall and sealingly engaged with the frunk hood, and
a tub floor surrounded by the tub wall; and
a dual plane load floor including
a load wall including a load upper ledge defining a load aperture sized to receive the tub post, and
a floor panel movable relative to the load wall between a storage position inhibiting access to the tub floor and a raised position providing access to the tub floor.

17. The vehicle of claim 16, wherein the tub further includes a front tub lip and the floor panel engages the front tub lip in the storage position.

18. The vehicle of claim 16, wherein an under-floor compartment is defined between the floor panel and the tub floor.

19. A vehicle comprising:
a storage compartment;
a vehicle component positioned within the storage compartment;
a hood selectively covering the storage compartment; and
a storage area load floor assembly coupled to the storage compartment and including
a tub covering the vehicle component, and
a dual plane load floor removably coupled to the tub and including a load wall and a floor panel,
wherein an under-floor compartment is defined between the floor panel and the tub.

20. The vehicle of claim 19, wherein the floor panel rotates relative the load wall between a storage position and a raised position.
